(19) United States
(12) Patent Application Publication
(10) Pub. No.: US 2014/0253038 A1
(43) Pub. Date: Sep. 11, 2014

(54) MOBILE DEVICES AND CASES WITH BUILT-IN POWER SUPPLIES

(71) Applicant: John G. Posa, Ann Arbor, MI (US)

(72) Inventor: John G. Posa, Ann Arbor, MI (US)

(21) Appl. No.: 13/792,883

(22) Filed: Mar. 11, 2013

(51) Int. Cl. H02J 7/00

(52) U.S. Cl. CPC H02J 7/0042
USPC 320/111

(57) ABSTRACT

Battery recharging apparatus for smart phones and other mobile devices eliminates the need to carry a separate charger and/or cord. A cradle receiving the portable electronic device includes a plug with at least two prongs configured to plug into a wall outlet supplying AC line voltage. A power supply in the case converts the AC line voltage into a low DC voltage, and a connector, configured to mate with the power input connector, provides the low DC voltage to the portable electronic device. The plug may include pivoting prongs that fold into the case during periods of non-use. Alternatively, a plug may be provided with a retractable cord enabling a user to extend the cord and plug for charging purposes and retract the cord and plug into the case during periods of non-use. The case may further include an auxiliary rechargeable battery.

### FIELD OF THE INVENTION

This invention relates generally to portable electronic devices and, in particular, to mobile devices and cases with built-in power supplies.

### BACKGROUND OF THE INVENTION

When people carry portable electronic devices such as cell phones, they often need to carry a charger as well, particularly when traveling. Chargers typically include a power adapter and a cable compatible with the device. Although power adapters have gotten more efficient and much smaller over the years, they still need to be carried separately and, if left somewhere, lost or stolen they can be expensive to replace.

### SUMMARY OF THE INVENTION

This invention resides in mobile devices with battery recharging apparatus thereby forgoing the need to carry a separate charger and/or cord. The invention is applicable to any portable electronic device such as a smart phone which has a power input connector for recharging a battery in the device using a low DC voltage.

An in-case embodiment of the invention comprises a cradle to receive the portable electronic device and a plug including at least two prongs configured to plug into a wall outlet supplying AC line voltage. A power supply in the case converts the AC line voltage into the low DC voltage, and a connector, configured to mate with the power input connector, provides the low DC voltage to the portable electronic device.

The case may include a plug with prongs having a retracted position within the case and a non-retracted position configured for plugging into a wall outlet. The plug may include pivoting prongs that fold into the case during periods of non-use. Alternatively, a plug may be provided with a retractable cord enabling a user to extend the cord and plug for charging purposes and retract the cord and plug into the case during periods of non-use.

The case may further include a rechargeable battery that receives the low DC voltage from the power supply to provide additional power to the portable electronic device through the connector even when not plugged into a wall outlet. The power supply is preferably a compact, thin transformerlesss power supply.

### BRIEF DESCRIPTION OF THE DRAWINGS

FIG. 1 is an oblique drawing of a preferred embodiment of the invention;

FIG. 2 is a side view of the preferred embodiment;

FIG. 3 is a back view;

FIG. 4 shows a smart phone with an in-case charger plugged into a wall outlet;

FIG. 5 illustrates a smart phone with an in-case charger and retractable cord plugged into a wall outlet;

FIG. 6 is a drawing of an alternative embodiment of the invention wherein the power supply and retractable cord and plug with prongs are contained in a portable electronic device without a case;

FIG. 7 is a drawing of an alternative embodiment of the invention wherein the power supply and fold-out plug with prongs are contained in a portable electronic device without a case;

FIG. 8 is a schematic diagram of a transformerless power supply applicable to the invention;

FIG. 9 depicts an alternative embodiment of the invention including a case with a retractable low-power connector; and

FIG. 10 depicts a further alternative embodiment of the invention including a portable electronic device with a retractable low-power connector.

### DETAILED DESCRIPTION OF THE INVENTION

This invention solves the problem of having to carry separate charging components for portable electronic devices by providing a built-in charger and plug, enabling the device, or a case carrying the device, to be plugged directly into a wall outlet. The configuration allows the user to carry only one item, namely the device itself or the device in a case. While specifically directed to smart phones, the invention is also suited to other portable electronic devices such as tablets and pad computers.

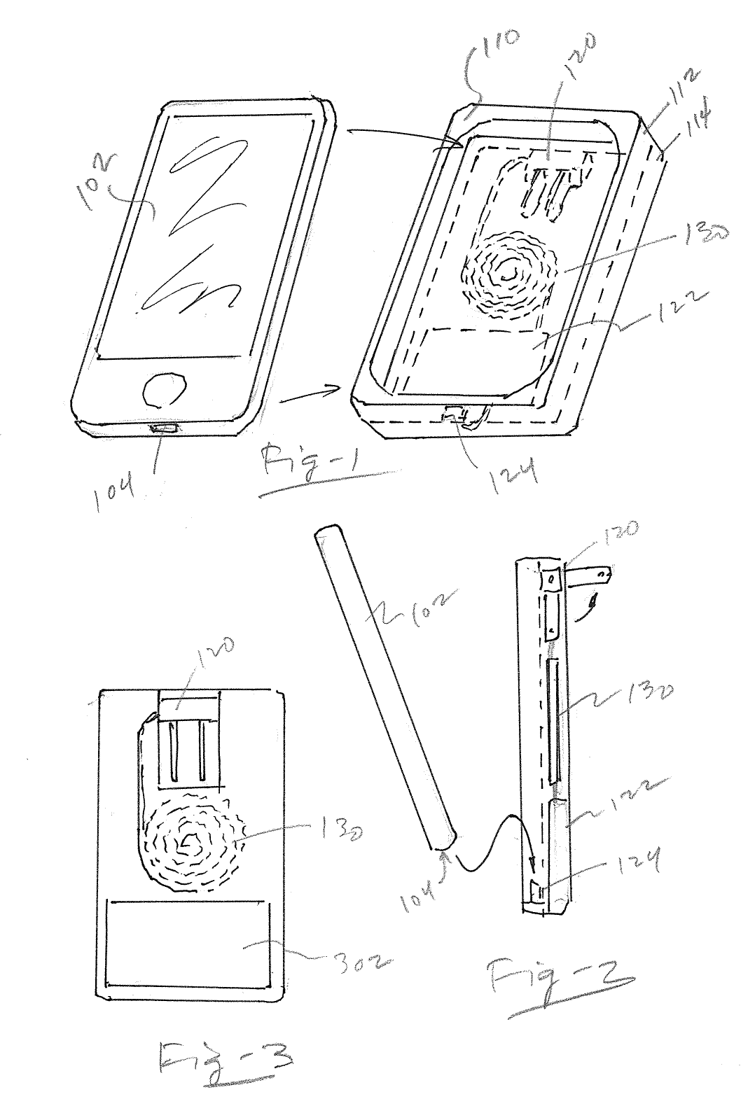

FIG. 1 is an oblique drawing of a preferred embodiment of the invention. An existing smart phone is shown at 102 which includes a power input connector 104. Although this happens to be an Apple i5, the invention is not limited in terms of the applicable portable electronic device. The invention resides in case 110, which includes a front cavity 112 to receive the phone and a rear portion 114 which includes a power plug 120, a power supply 122 in electrical communication with the plug, and a connector 124 that mates with connector 104 on the phone. If the connector on the phone does not lend itself to a direct connection, the case may include a short cord to interface with the connector 104 on the mobile device.

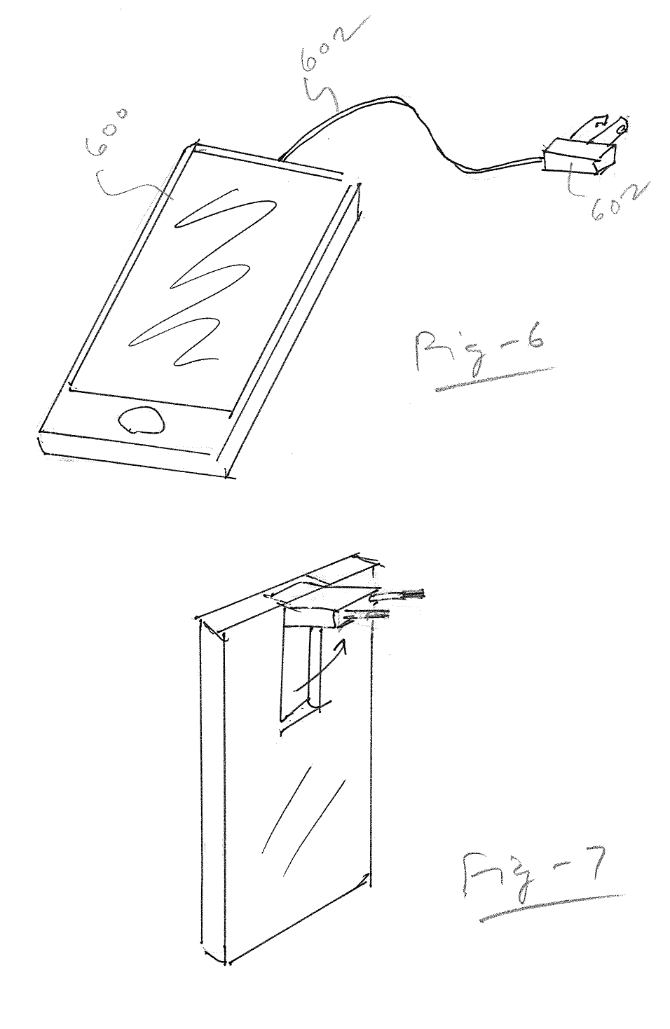

Also shown in FIG. 1 is an optional spring-biased reel 130 enabling the plug to be detached from the case and plugged into the wall as shown in FIG. 5. Without the cord and retraction assembly, the plug may simply fold out (or otherwise extend outwardly from the case), enabling the case with phone to be plugged into the wall as shown in FIG. 4. The advantage of the retractable cord is that the used can more easily use the phone while charging. The cord is preferably spring biased such that a slight pull on the cord while extended causes the cord to return to the case like other retractable cord systems.

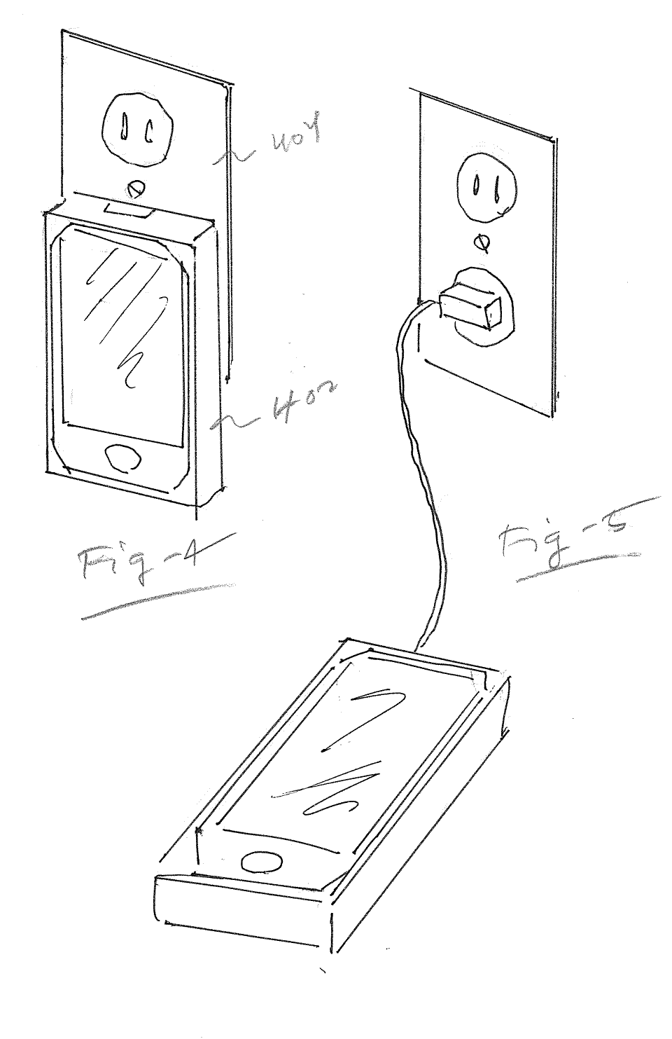

FIG. 2 is s side view showing the device 102 being placed into the case such that the connector 104 automatically mates with the corresponding connector 124 in the case. The plug folds out from a retracted position in the case to an extended position for plugging into a wall outlet. The option retractable cord is shown at 130 and power supply is depicted at 122. The case may further include one or more rechargeable batteries, within module 122, for example, to provide additional power to the device even when not plugged into a wall outlet. Device recognition electronics may additionally be included enabling standard interfaces to provide more power to the device than the standard prescribes. For example, certain Apple devices send a signal to the charger telling it to supply more than 2 amps of current which exceeds the existing USB interface. FIG. 3 is a back view showing the plug 120, cord reel 130 and panel 302 to access supplemental rechargeable batteries if so provided.

Power supply 122 converts line voltage into a low voltage DC compatible with the phone; 5 volts, for example. For the sake of appearance it is important that the power supply be as compact and thin as possible. Although switch-mode power supplies with small transformers may be used, the preferred design uses a transformerless circuit, with one implementation being depicted in FIG. 8. The diodes forming the bridge rectifier are 1N4007 devices. The input capacitor is 4.7 uF/400V, and the output capacitor is 1 uF/25V. The FET is a DN2540N5.

The ICs in the circuit of FIG. 8 are the LR645LG from Supertex Electronics and a common 7805 5V regulator. The LR645G chip controls any voltage between 24 and 270 V AC and produces DC voltages below 15 volts at the output, which is well suited for powering sensitive, compact electronic circuits. The circuit does not incorporate any bulky or heavy components like transformers or non-polarized high-voltage capacitors. The maximum current available from this device is quite low, around 3 mA, but the current may be increased to 150 mA using the FET. Although this circuit will output 5V at up 150 mA, different voltages and higher currents may be accommodated through appropriate component selection.

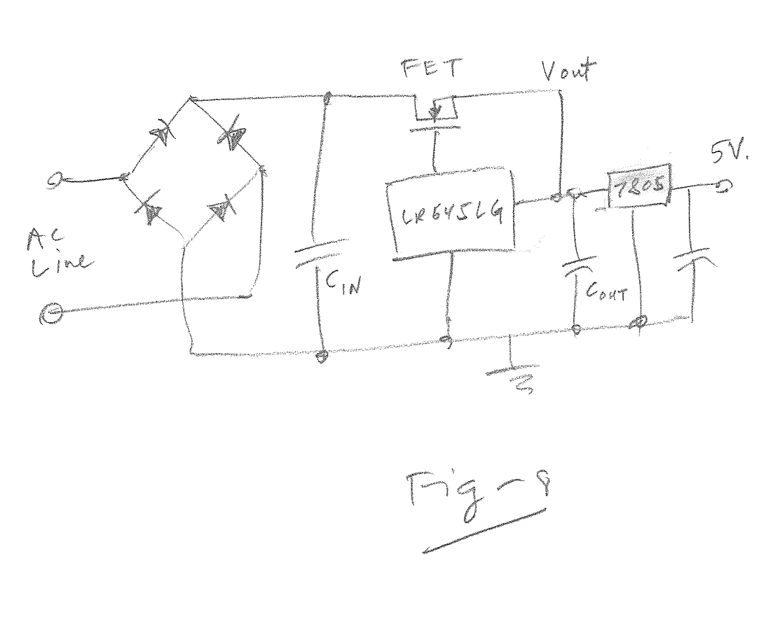

As technology allows, the plug with prongs and power supply may be embedded directly into the smart phone or other portable electronic device without the need for a case. Depending upon packaging constraints, the device itself 600 may include an extendable cord 602 with pronged plug 606 for insertion into a wall outlet as shown in FIG. 6. With or without a retractable cord, the prongs may fold out or otherwise extend directly from device 702 enabling the device itself to plug into wall outlet as shown in FIG. 7.

The invention is compatible with any plug configuration, including the NEMA 1-15 (15 A/125 V unearthed) (Type A) standard for the North American market shown in FIGS. 1, 2 and 4-6, or the Soviet/Schuko/Europlug types best seen in FIGS. 3 and 7. With three-pronged configurations the ground plug may either be eliminated or a more sophisticated extension/folding mechanism may be used.

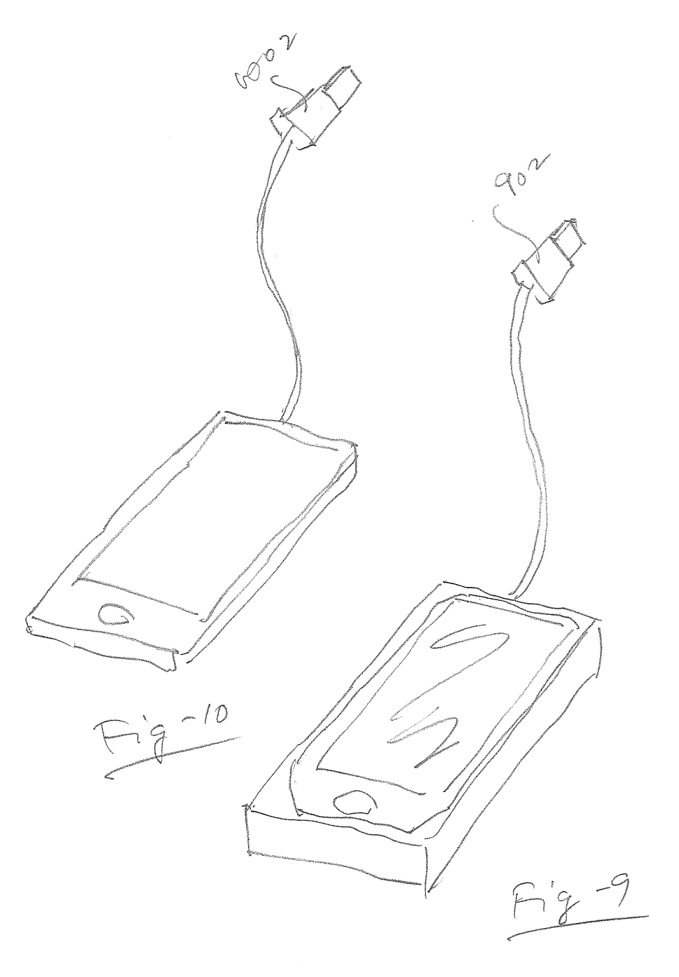

The popularity of certain low-power connection systems has resulted in outlets being available for DC voltages without the need for conversion of AC. FIG. 9 depicts an alternative embodiment of the invention including a case with a retractable low-power connector 902, and FIG. 10 depicts a further alternative embodiment of the invention including a portable electronic device with a retractable low-power connector 1002. At present it is envisioned that such connectors would be in the USB family, which would include USB Type-A, Type-B, Mini-B, Micro-A and Micro-B. The in-case version of FIG. 9 would optionally include an additional battery to extend the life of the smart phone or other device, and both embodiments of FIGS. 9, 10 may have fold-out connector as opposed or in addition to retractable cords, and either or both may have electronics to supply over-current as discussed above in [0020].

1. A case for a portable electronic device having a power input connector for recharging a battery in the device with a low DC voltage, the case comprising:
a cradle to receive the portable electronic device;
a plug including at least two prongs configured to plug into a wall outlet supplying AC line voltage;
a power supply in the case operative to convert the AC line voltage into the low DC voltage; and
a connector configured to mate with the power input connector to provide the low DC voltage to the portable electronic device.

2. The case of claim 1, including a plug with prongs having a retracted position within the case and a non-retracted position configured for plugging into a wall outlet.

3. The case of claim 1, including a plug with pivoting prongs that fold into the case during periods of non-use.

4. The case of claim 1, including a plug on a retractable cord in the case enabling a user to extend the cord and plug for charging purposes and retract the cord and plug into the case during periods of non-use.

5. The case of claim 1, including two prongs compatible with the NEMA 1-15 (15 A/125 V unearthed) (Type A) standard.

6. The case of claim 1, including two prongs compatible with Europlug or Soviet-style Schuko plugs.

7. The case of claim 1, wherein the case further includes a rechargeable battery that receives the low DC voltage from the power supply to provide additional power to the portable electronic device through the connector even when not plugged into a wall outlet.

8. The case of claim 1, wherein the power supply is a transformerlesss power supply.

9. The case of claim 1, including a cradle configured to receive a smart phone.
